(19) United States
(12) Patent Application Publication
(10) Pub. No.: US 2018/0313467 A1
(43) Pub. Date: Nov. 1, 2018

(54) Modular Lay System

(71) Applicant: IHC Engineering Business Limited, Stocksfield, Northumberland (GB)

(72) Inventor: Martin Fletcher BINGHAM, Stocksfield, Northumberland (GB)

(73) Assignee: Royal IHC Limited, Stocksfield, Northumberland (GB)

(21) Appl. No.: 15/766,433

(22) PCT Filed: Sep. 19, 2016
(86) PCT No.: PCT/GB2016/052922

§ 371 Date: Apr. 6, 2018

(30) Foreign Application Priority Data
Oct. 7, 2015 (GB) 1517724.9

(51) Int. Cl. F16L 1/16; E21B 19/22; F16L 1/23; B33Y 80/00

(52) U.S. Cl. CPC F16L 1/16; B33Y 80/00; F16L 1/23; E21B 19/22

(57) ABSTRACT

A modular lay system for laying of an elongate element. The system includes a module for positioning on a deck of a vessel or the ground, the module configured to be connected to a further module. The system further includes a diverter module configured to be connected to the module or a further module. The module includes a top side having a shape and size to be releasably connected, in use, with either the diverter module, or a further module in the vertical direction. The module also includes a further side having a shape and size to be releasably connected, in use, with a further module in the horizontal direction.

The present invention relates to a modular lay system for laying of an elongate element. More specifically, although not exclusively, the present invention relates to a modular lay system including elements that can be arranged both horizontally and vertically on a deck of a vessel.

### BACKGROUND

Subsea pipes and cables are often installed into a subsea environment from a vessel. A laying system is usually installed onto the deck of a vessel and an elongate member (for example a pipe or a cable) is payed out into the sea via the laying system.

Laying systems can also be employed for well intervention operations, when using coiled tubing, for example.

A typical laying system may include a tower-like structure located above a vertical passage or moon pool in the vessel, or mounted over a side or the stern of a vessel. The tower-like structure includes a guide for guiding a pipe or cable over the laying system and down towards the vertical passage in the vessel or over the side of the vessel. The tower-like structure may also include one or more tensioners for applying or maintaining tension in the pipe or cable.

An example of a known laying system is described in EP 0717221. The apparatus includes a frame structure having a lower part forming a working arch, an upper part to which tensioners are attached and a top side rotating assembly including a guide arch. Each of the parts are constructed separately and assembled on site.

Various different lay system structures are known, and a different structure may be preferred to suit a particular usage scenario.

Often, a particular vessel may be required that is suitable for supporting a laying system and pipe or cable. For example, the vessel may need to withstand larger loads for one particular laying system compared to other laying systems.

In some situations it may be that a particular lay system structure is preferred but the suitable vessel is not available when needed and this can delay the installation of pipe or cable.

It is therefore desirable to have a laying system that can be used on a wider range of vessels than previously known systems.

### BRIEF SUMMARY OF THE DISCLOSURE

In accordance with a first aspect of the present invention, there is provided a modular lay system for laying of an elongate element comprising:
a module for positioning on a deck of a vessel or the ground, the module configured to be connected to a further module; and
a diverter module configured to be connected to the module or a further module;
wherein the module comprises:
   a top side having a shape and size to be releasably connected, in use, with either the diverter module, or a further module in the vertical direction, and
   a further side having a shape and size to be releasably connected, in use, with a further module in the horizontal direction.

The invention may be suitable for laying of elongate elements (e.g. pipe or cable) from a vessel into a subsea environment. The invention may also be suitable for laying an elongate element (e.g. coiled tubing) for well intervention operations.

Thus, the invention provides a modular laying system that may be configured to extend either vertically (e.g. above a deck) or horizontally (e.g. across a deck).

The modular lay system may further include a chute, or wheel connected to or formed integrally with the diverter module. For example, the chute or wheel may be a separate component to the diverter module and may be connected to the roller chute module during installation. The chute or wheel may be connected to the diverter module via nuts and bolts, for example, to form a releasable connection, or may be welded together, for example, to form a permanent connection. The wheel may be connected to the diverter module in a manner such that the wheel is rotatable about a central axis with respect to the diverter module. The chute may be a tracked chute, may include rollers, or may be a plain chute. Such chutes are known in the art, and for brevity will not be described in detail.

The modular lay system may further include a further module. The further module may be connected to the top side of the module, for example, and the diverter module may be connected to a top side of the further module. Thus, the module, further module and diverter module may form a vertical tower lay system. Alternatively, the further module may be connected to a side of the module (i.e. horizontally adjacent the module, in use), and the diverter module may be connected to the top side of the module. Thus, the module, further module, and diverter module may form a horizontal lay system.

The further module is aptly configured for connecting a tensioner thereto. For example, one or more sides of the further module may be of suitable size and shape for connecting a tensioner thereto.

The modular lay system may further include a ramp module configured for connection with the module. The ramp module may aptly include an inclined side. A further side of the ramp module is aptly sized and shaped to be releasably connected in use, with the further side of the module. The ramp module and module may therefore be connected together in a substantially horizontal direction (e.g. across a deck).

The inclined side of the ramp module is aptly configured for connecting a tensioner thereto. For example, the inclined side may be of suitable size and shape for connecting a tensioner thereto.

The modular lay system may further include a tensioner. The tensioner may be any known tensioner suitable for tensioning the elongate member. For example, a shorter tensioner may be used for a pipe or cable that has a higher crush resistance and a longer tensioner may be required for a pipe or cable having a lower crush resistance. A person skilled in the art will readily determine the most suitable tensioner for a specific elongate member.

The tensioner may be connected to a ramp module or further module. In the vertical system, the tensioner may be connected to any further module. Preferably the tensioner is connected to a further module at a suitable height above the deck or ground to allow sufficient working area below the tensioner. For example, the tensioner may be positioned at a suitable height above deck or ground to allow space for an end fitting to be connected to a pipe. This may require the tensioner to be positioned at a minimum height of around 4 m to 6 m, for example, to accommodate the length of the end fitting. In a horizontal system, the tensioner may be connected to the inclined side of the ramp module to thereby guide the elongate member onto the diverter module (including a chute or wheel, for example).

The module or further module may include one or more discrete parts configured to be connected together. Each discrete part may be the same size and shape or optionally may be of different size and shape. For example, each discrete part may itself form, for example, a sub-module. The sub-module may then be used in place of a full size module to offer further flexibility in the overall height of the modular lay system. The discrete parts may be releasably connected together using, for example nuts and bolts.

Providing the module or further module as multiple sub-modules can also ease transportation and installation.

Optionally one or more of the discrete parts may include a ramp module. The ramp module formed by the discrete part may be substantially the same as the ramp module described above having an inclined side for attachment of a tensioner thereto. Aptly, two of the discrete parts may include a ramp module, and can be connected together to form a further module as described above.

The modular lay system may include one or more connecting element for connecting two or more modules (or two or more discrete parts) together. The connecting element may include nuts and bolts, connecting brackets, quick-release connectors, rack and pinions, pins, clamps, expanding sockets, wedges or any other suitable releasable connector.

The modular lay system may further include a workstation platform for positioning adjacent the module. The workstation platform may provide a space adjacent the module on the deck (or ground) for carrying out work on the elongate member as it is payed out into the sea (or into a well). Optionally the workstation platform may be formed integrally with the adjacent module.

The module may include one or more of a control room, a hydraulic power unit, an electronic power unit, a workstation, a hang off clamp, and gantry beams. One or more of these components may be provided separately and assembled on site to ease transportation.

According to a second aspect of the present invention, there is provided a module suitable for use with the modular lay system as described above. The module may be any of the module, further module, or diverter module as described above.

Another aspect of the invention provides a computer program element including and/or describing and/or defining a three-dimensional design for use with a three-dimensional printing means or printer or additive manufacturing means or device, the three-dimensional design including one or more components of an embodiment of the modular lay system described above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed.

### BRIEF DESCRIPTION OF THE DRAWINGS

Embodiments of the invention will now be described by way of example only with reference to the accompanying drawings in which:

FIG. 1 shows a front elevation view of a modular lay system in a vertical configuration;

FIG. 2 shows a side elevation view of a modular lay system in a vertical configuration;

FIG. 3 shows a perspective view of a modular lay system in a vertical configuration;

FIG. 4 shows a plan view of a modular lay system in a horizontal configuration;

FIG. 5 shows a side elevation view of a modular lay system in a horizontal configuration;

FIG. 6 shows a perspective view of a modular lay system in a horizontal configuration.

### DETAILED DESCRIPTION

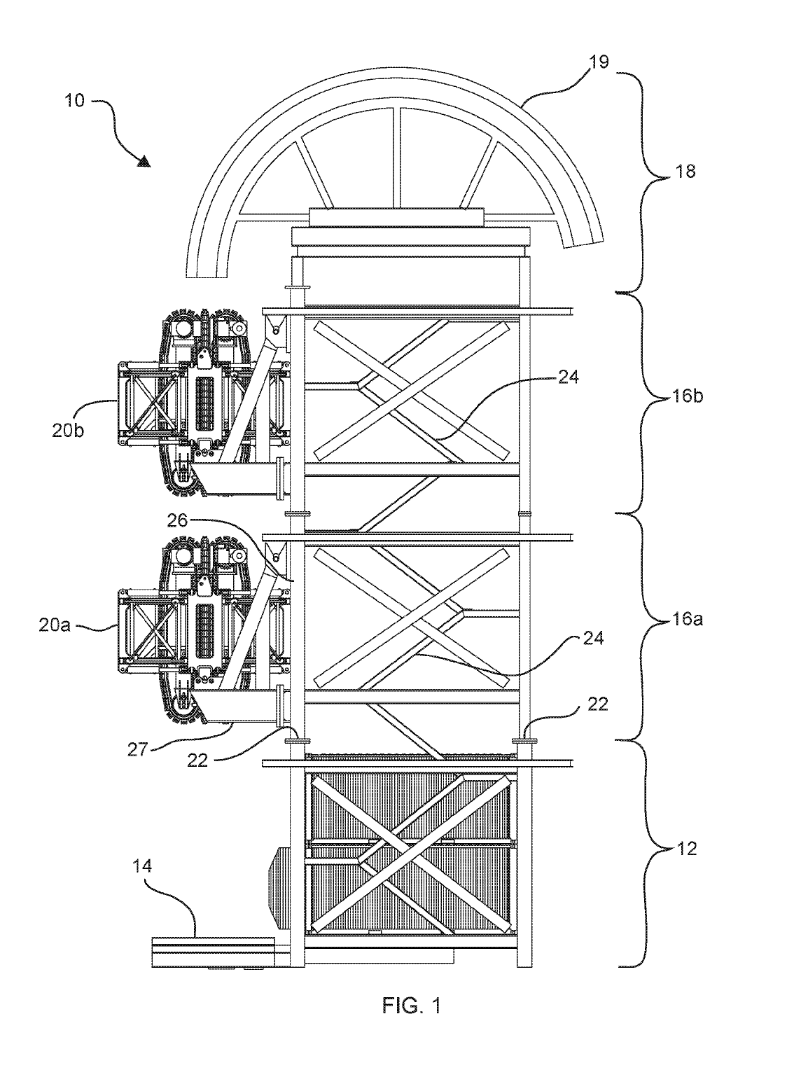

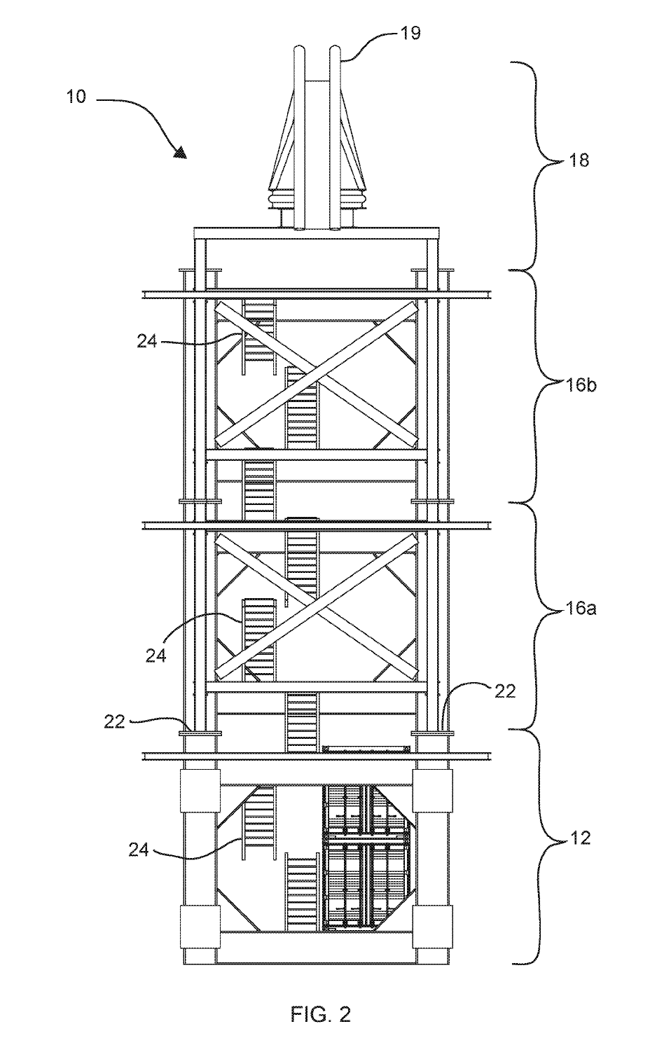

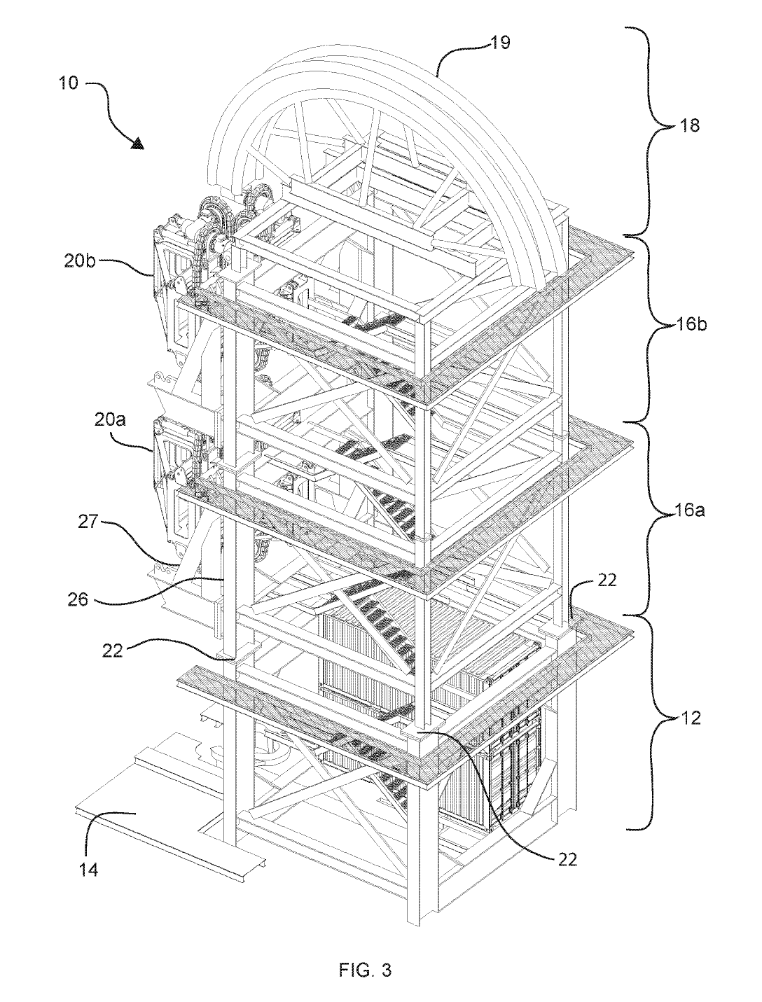

Referring now to the drawings, FIGS. 1 to 3 show an example of a modular lay system 10 arranged in a vertical (tower) configuration.

The modular lay system 10 includes a module 12. The module 12 is positioned on the deck of a vessel (not shown) and forms a base for the vertical configuration.

The module 12 is substantially cubic in shape and is formed from a series of interconnected steel beams. The module includes a control room for controlling different elements of the system 10, in use. The module also includes a hydraulic power and electrical power supply unit (HPU and EPU) for supplying hydraulic and electrical power to different components of the system 10.

In this embodiment, the module 12 also includes a workstation platform 14. The workstation platform 14 provides an area in which work may be carried out on an elongate member. For example, for a pipe, the workstation provides an area where an end fitting may be fitted to a pipe to terminate a section of pipe.

Further modules 16a, 16b are connected in sequence vertically above the module 12. Further module 16a is connected to a top side 22 of module 12. In this example, the top side 22 includes four supporting surfaces, each positioned at a corner of the module 12.

The top side 22 of module 12 is sized and shaped for connection with a bottom side of the further module 16. The module 12 is releasably connected to the further module 16a via nuts and bolts.

This example includes two further modules 16a, 16b. Each of the two further modules 16 are identical and each have a bottom side sized and shaped to be releasably connected with the top side 22 of module 12 or the top side of a further module 16.

The top side of the further module 16 is sized and shaped to be releasably connected with the bottom side of a further module 16 or a bottom side of a diverter module 18.

The diverter module 18 provides support for a chute or wheel or other product diverter (guide). The diverter is suitable for guiding an elongate member (product, e.g. a pipe or cable) over the lay system and towards a vertical passage or moon pool of a vessel or over the side of a vessel. The diverter module may also provide mounting points. The mounting points may be suitable for mounting abandonment and recovery sheave posts or cranes, for example. Abandonment and recovery sheave posts and cranes are well known in the art and, for brevity will not be discussed in detail.

In this example each of the further modules are formed from a series of interconnected steel beams, and are substantially cubic in shape.

A side of each of the further modules 16 is configured for connecting a tensioner 20 thereto.

In this example a substantially vertical side 26 of the further module 16 is suitably sized and shaped for a tensioner 20 to be connected thereto. The vertical side 26 includes a support 27 to which the tensioner can be connected.

The tensioner 20 is releasably connected to the vertical side 26 using nuts and bolts so that it can be disconnected and reassembled as required.

The diverter module 18 provides a support for a diverter, in this example a chute 19. In this example, the chute 19 is formed integrally with (i.e. permanently connected to) the diverter module 18. The chute 19 acts as a guide for an elongate member (e.g. a pipe or cable), and in use guides the elongate member over the top of the tower configuration and downwards towards the tensioners 20a, 20b. In this example the chute 19 includes rollers (not shown) to help aid the passage of an elongate member around the chute.

The diverter module 18 has a bottom side that is sized and shaped for releasable connection with either the top side 22 of the module 12 or the top side of the further module 16. As such, the diverter module 18 can connect to a further module 16 or the module 12.

Each of the modules 12, 16 also includes stairs or ladders 24 for providing an access route for a user to access each of the modules or components (e.g. tensioners 20).

In use, an elongate member (e.g. a pipe, cable, or tubing) will be passed from a reel or from another storage area on deck, over the chute 19 and then through the tensioners 20. Once the elongate member exits the tensioners it can be worked on by a user in the workstation platform area if necessary, and then fed through a vertical passage or moon pool in the vessel, or over the side of the vessel.

Each component of the modular lay system (e.g. the module 12, further modules 16, diverter module 18 and tensioners 20) can be supplied as separate components (i.e. disconnected from each other). The components can then be assembled on board a vessel into the configuration shown in FIGS. 1 to 3. Alternatively the components can be supplied pre-assembled.

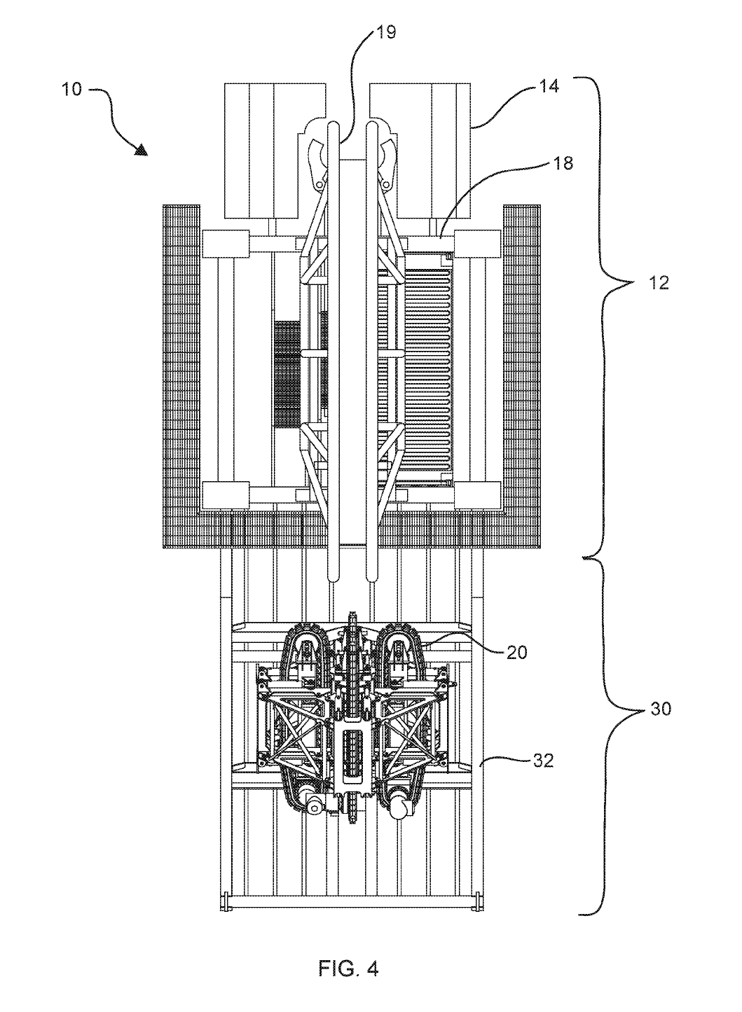

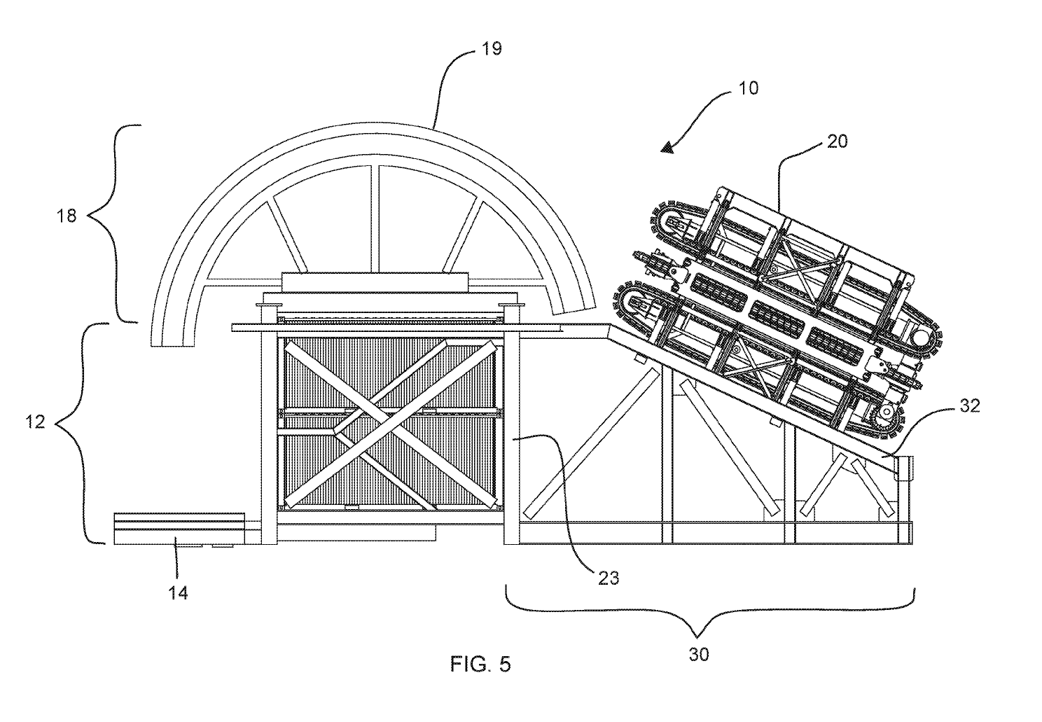

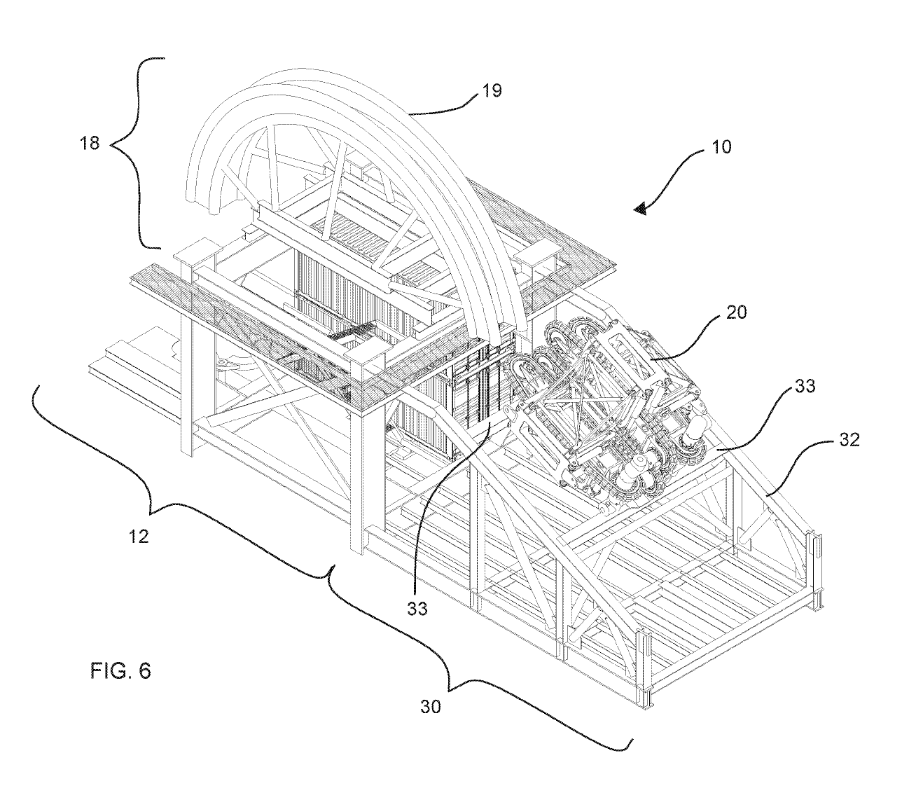

Alternatively, the components of the modular lay system of FIGS. 1 to 3 may be assembled as shown in FIGS. 4 to 6. Here the modular lay system 10 is assembled in a horizontal configuration.

In this configuration the diverter module 18 is connected to the top side of the module 12. In this configuration the modular lay system 10 is therefore shorter height than in the vertical configuration shown in FIGS. 1 to 3.

A ramp module 30 is connected to a further side 23 of the module 12. The ramp module 30 includes an inclined side 32. The inclined side 32 is configured for connecting a tensioner 20 thereto. In this example, the inclined side 32 includes spaced apart cross beams 33 to which the tensioner 20 is connected. The tensioner is releasably connected to the cross beams 33 via nuts and bolts.

A further side of the ramp module 30 adjacent the top of the inclined side 32 is configured for releasable connection with the further side 23 of the module 12. That is, the further side of the ramp module 30 is sized and shaped for releasable connection with the further side 23 of the module 12.

In this example the ramp module 30 is formed from a series of interconnected steel beams.

In use, an elongate member (e.g. a pipe or cable) will be passed through the tensioner 20 and over the chute 19. The chute 19 guides the elongate member to a vertical position where, at an appropriate time, it can be fed through a vertical passage or moon pool in a vessel, or over the side of the vessel.

Although the embodiment above has been described having a substantially cubic module and substantially cubic further modules, the modules may alternatively be any other suitable shape. For example, the module and/or further module may be rectangular in cross-section and therefore cuboidal in shape. Alternatively, the module or further module may be narrower in cross-section at the top side than at the bottom side, forming a substantially trapeze shaped cross-section. For any shape module or further module, the top side of the module or further module should be sized and shaped so that it can be releasably connected to at least a portion of a bottom side of another module.

Although in the example described above, the modules are formed from a series of interconnected steel beams, the modules may alternatively be formed from any other suitable structural material.

The skilled person will appreciate that materials and structure of the modules should be selected such that the assembled modular lay system can typically be capable of withstanding an appropriate tension load for the desired use, e.g. tension loads of around 150 tonnes. Other systems may be required to withstand tension loads of e.g. around 75 tonnes, or up to around 650 tonnes, for example.

In an alternative embodiment, each module itself may be formed from separate discrete parts. For example, the further modules 16 may be formed from two or more discrete parts. The discrete parts may be connected together to form a complete module 16. In some embodiments the discrete parts may be releasably connected together using e.g. nuts and bolts. In other embodiments the discrete parts may be permanently connected e.g. welded together.

In some embodiments one or more of the discrete parts may form a ramp module 30 or part of a ramp module 30.

In some embodiments, the ramp module 30 may be formed from separate discrete parts. Each of the separate discrete parts may optionally be part of one or more further modules 16.

The module 12 may also formed from separate parts. For example, the control room, hydraulic power unit, electronic power unit and work station platform may be provided separately and assembled together on deck (or on the ground). Of course, in certain embodiments one or more of the control room, hydraulic power unit, electronic power unit and work station platform may not be required.

In some embodiments the module 12 may include a hang off clamp and/or gantry beams. The hang off clamp may be used to suspend the end of the product (elongate member) to allow for other items to be attached to it or for disconnecting a product made in multiple sections, for example. The gantry beams may be used to suspend equipment and material above the working area.

Although in the vertical configuration of FIGS. 1 to 3 above, the modular lay system is shown having two further modules 16, any suitable number of further modules may be used. For example, the system may typically include between one and four further modules 16. In other configurations the system may include more than four further modules 16. One or more of the further modules 16 may have a tensioner 20 connected thereto.

Although in the horizontal configuration of FIGS. 4 to 6 above, the modular lay system is shown having one ramp module 30, any suitable number of ramp modules in combination with further modules 16 may be used. For example, a configuration having two ramp modules 30 may include a module 12 positioned on the deck of a vessel. A first further module may be connected adjacent the module 12 in a horizontal configuration, and a second further module 12 connected to the top side 22 of the module 12 in a vertical configuration. A diverter module 18 including a suitable diverter (e.g. a chute) may be connected to a top surface of the second further module 16. Two ramp modules may be respectively connected to a top side and vertical side of the first further module in a manner so as to form a substantially continuous inclined side from the deck of the vessel to the bottom side of the diverter module. This arrangement having multiple ramp modules may be beneficial where a longer tensioner or multiple tensioners are required as it effectively increases the length of the inclined side to which one or more tensioners may be connected.

Although in the examples above, components have been described as releasably connected via nuts and bolts, it will be appreciated that other releasable connection means may be used. For example, connection means may include straps, push fit mechanisms, connecting plates, releasable latches, locking mechanisms, quick-release connectors, rack and pinions, pins, clamps, expanding sockets, wedges or any other suitable releasable connector.

The modules described above may be provided as a kit of parts.

After use in one arrangement, the modules may be disassembled and re-configured into another arrangement for a different use.

Certain aspects of the invention described above provide the advantage that a modular laying system can be assembled in various configurations, such that it can be suitable for a wide variety of uses and a wide variety of vessels.

With the modular system described above, additional modules may be included or omitted during assembly as required.

The modular system described above may be assembled in a vertical configuration where deck space on a vessel is limited. This may enable vessels with limited deck space to be used.

The modular system described above may alternatively be assembled in a horizontal configuration. This may be beneficial where a deck is not strong enough to support a vertical system, because the load can be spread over a larger surface area.

The modular lay system described above eliminates the need to have several lay systems, each designed to fit a specific vessel.

The modular lay system described herein is suitable for laying an elongate member (e.g. pipe or cable) from a vessel into the sea and may also be suitable for laying coiled tubing for well intervention operations. It will be appreciated that the modular lay system described above is suitable for positioning on either a deck of a vessel or the ground.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

It will be appreciated by those skilled in the art that several variations to the aforementioned embodiments are envisaged without departing from the scope of the invention. It will also be appreciated by those skilled in the art that any number of combinations of the aforementioned features and/or those shown in the appended drawings provide clear advantages over the prior art and are therefore within the scope of the invention described herein.

1. A modular lay system for laying of an elongate element comprising:
a module for positioning on a deck of a vessel or the ground, the module configured to be connected to a further module; and
a diverter module configured to be connected to the module or a further module;
wherein the module comprises:
a top side having a shape and size to be releasably connected, in use, with either the diverter module, or a further module in the vertical direction, and
a further side having a shape and size to be releasably connected, in use, with a further module in the horizontal direction.

2. A modular lay system as claimed in claim 1, further comprising a chute, or wheel connected to or formed integrally with the diverter module.

3. A modular lay system as claimed in claim 1, further comprising the further module.

4. A modular lay system as claimed in claim 3, wherein the further module is configured for connecting a tensioner thereto.

5. A modular lay system as claimed in claim 1, further comprising a ramp module configured for connection with the module.

6. A modular lay system as claimed in claim 5, wherein the ramp module is configured for connecting a tensioner to an inclined side thereof.

7. A modular lay system as claimed in claim 1, further comprising a tensioner.

8. A modular lay system as claimed in claim 3, wherein the further module comprises two or more discrete parts configured to be connected together.

9. A modular lay system as claimed in claim 8, wherein one or more of said discrete parts comprises a ramp module.

10. A modular lay system as claimed in claim 1, further comprising one or more connecting element for connecting two or more modules together.

11. A modular lay system as claimed in claim 1, further comprising a workstation platform for positioning adjacent the module.

12. A modular lay system as claimed in claim 1, wherein the module comprises one or more of a control room, a hydraulic power unit, an electronic power unit, a workstation, a hang off clamp, and gantry beams.

13. A module suitable for use with the modular lay system as claimed in claim 1.

14. A computer program element comprising a three-dimensional design for use with a three-dimensional printing or additive manufacturing means or device, the three-dimensional design comprising an embodiment of the module of claim 13.

15. (canceled)
